(19) United States
(12) Patent Application Publication
(10) Pub. No.: US 2003/0187784 A1
(43) Pub. Date: Oct. 2, 2003

(54) System and method for mid-stream purchase of products and services

(76) Inventors: Michael Maritzen, Fremont, CA (US); Kiyohiko Niwa, Haworth, NJ (US); Yoshihiro Tsukamura, Mahwah, NJ (US)

Correspondence Address: Valley Oak Law, 5655 Silver Creek Valley Road, # 106, San Jose, CA, 95138, US

(21) Appl. No.: 10/109,515

(22) Filed: Mar. 27, 2002

(51) Int. Cl. G06F 17/60

(52) U.S. Cl. 705/39

(57) ABSTRACT

A system and method for providing a mid-stream payment model that automatically transfers funds from a consumer to a merchant are described. The invention allows a consumer to create, edit, and store profile information including merchants, and corresponding consumer accounts, increment payments and total transaction costs. In one embodiment, the invention includes a matching module for matching a merchant to a plurality of listed merchants from a merchant list and identifying a selected consumer account based on the merchant; a connection module coupled to the matching module for automatically connecting the merchant with the selected consumer account; and a transfer module coupled the connection module for transferring funds from the selected consumer account to the merchant in response to a confirmation.

### BACKGROUND OF THE INVENTION

Electronic commerce is achieving widespread use. Transactions are performed everyday over the Internet and through point of sale (POS) or bank systems. Such transactions are typically performed after the person requesting access to some information is authenticated and access is given to that person's private information, such as financial, medical, or other type of restricted records. Present systems are designed to maintain the integrity of the user's credit card, debit card, and account number. However, no measures are taken to ensure the secure authentication of the user in order to prevent unauthorized access by a potential thief.

Presently, applications providing access to sensitive information are based upon information that a potential thief may appropriate with relative ease. For example, some of the information presently required to grant access to sensitive material, such as a person's Social Security Number, date of birth, or mother maiden's name, is readily available. Once a potential thief collects any two pieces of this information, the thief may obtain access to the person's financial, medical, or other private information. In addition, most secure access systems are set up to divulge a person's entire file, once they receive the appropriate password and/or correct answers to the security questions. Therefore, a potential thief may steal the person's identity and ruin that person's credit.

Presently, existing payment systems typically utilize legacy system architectures and transaction flows that are based on a batch system for payment. By utilizing the batch system, individual payments from the consumer to the merchant are held until a predetermined number of individual payments are grouped together or a predetermined amount of time has passed. By utilizing the batch system, transactions are not reliably transmitted in real-time. In a dispute between a consumer and a merchant, the existing payment systems typically find in favor of the consumer partly due to the latency of the settlement charges.

### SUMMARY OF THE INVENTION

A system and method for providing a mid-stream payment model that automatically transfers funds in real-time from a consumer to a merchant are described. The invention allows a consumer to create, edit, and store profile information including merchants, and corresponding consumer accounts, increment payments and total transaction costs. In one embodiment, the invention includes a matching module for matching a merchant to a plurality of listed merchants from a merchant list and identifying a selected consumer account based on the merchant; a connection module coupled to the matching module for automatically connecting the merchant with the selected consumer account; and a transfer module coupled the connection module for transferring funds from the selected consumer account to the merchant in response to a confirmation.

### BRIEF DESCRIPTION OF THE DRAWINGS

The present invention is illustrated by way of example and not limitation in the figures of the accompanying drawings, in which like references indicate similar elements and in which:

FIG. 1 is a simplified block diagram of one embodiment of a secure transaction system.

FIG. 2 is a simplified block diagram of one embodiment of a privacy card for a personal transaction device.

FIG. 3 is a simplified block diagram of one embodiment of a digital wallet for a personal transaction device.

FIG. 4 is a simplified block diagram of one embodiment of a secure transaction system showing a point-of-sale terminal.

FIG. 5 is a simplified block diagram of one embodiment of a transaction privacy clearing house.

FIG. 6A illustrates one embodiment of profile information.

FIG. 6B is a simplified block diagram of one embodiment of a payment system.

FIG. 7 illustrates a flow diagram for performing one embodiment of an initialization.

FIG. 8 illustrates a flow diagram for performing one embodiment of a real-time payment model.

### DETAILED DESCRIPTION

In the following descriptions for the purposes of explanation, numerous details are set forth in order to provide a thorough understanding of the present invention. However, it will be apparent to one skilled in the art that these specific details are not required in order to practice the present invention. In other instances, well-known electrical structures or circuits are shown in block diagram form in order not to obscure the present invention unnecessarily.

A system and method for mid-stream purchase of products and services automates the task of making payments from the consumer to the merchant. The system and method also enable these payments to be made in real-time and enable payment from the consumer to the merchant while the consumer is receiving the goods or consuming the services. The system and method also does not necessarily require any manual intervention by the consumer. In one embodiment, the system and method also allow for user authentication such as through biometric identification, token exchange, PIN entry, and the like. In one embodiment, the invention operates in conjunction with a secured transaction exchange, controlled content access, and the like.

Security of the user's identity may be achieved in a variety of ways. In one embodiment, a single trusted location. For example, a transaction privacy clearing house (TPCH) contains user data. The user interfaces with the TPCH using the user's transaction device. The user therefore does not fill out online the electronic purchase forms at every product vendor's website. The TPCH acts as a financial transaction middleman, stripping off user identity information from transactions. As a result, the user's private information is not stored in several databases across the Internet and in private business networks. The secure locations where the financial data is stored minimizes the possibilities that hackers can access the data or accidental releases of the data can occur. Mutliple secure locations also prevent the theft of confidential information.

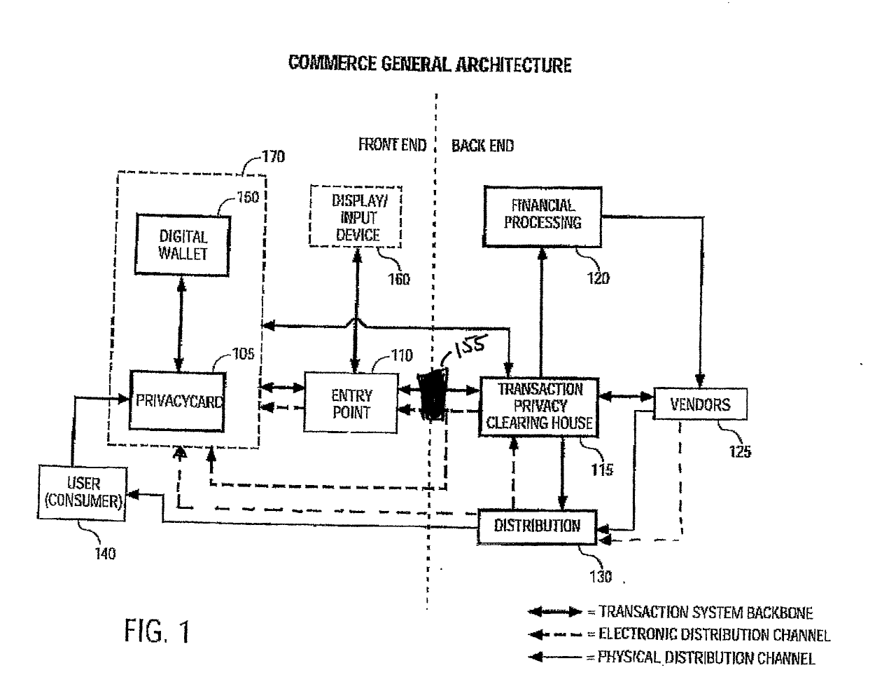

FIG. 1 is a simplified block diagram of one embodiment of a secure transaction system, which may be used in electronic commerce. As illustrated in FIG. 1, in this embodiment, a transaction privacy clearing house (TPCH) 115 interfaces a user (consumer) 140 and a vendor 125.

In this particular embodiment, a personal transaction device (PTD) 170, e.g., a privacy card 105, or a privacy card 105 coupled to a digital wallet 150, is used to maintain the privacy of the user while enabling the user to perform transactions. The personal transaction device 170 may include a window interface, a privacy card, a digital wallet, a point of sale terminal, a laptop computer, a desktop computer, a PDA, or any other device under the control of the user 140.

The personal transaction device 170 provides an interface for the user to exchange information. This exchange of information may include but is not limited to the user 140 receiving audio and/or visual content, instructions, requests, and the like from the personal transaction device 170. Further, this exchange of information may also include but is not limited to the personal transaction device 170 receiving instructions, payment authorization, authentication, and the like from the authorized user 140.

In one embodiment, the personal transaction device 170 is a fixed window interface within kiosk at a mall. Both the mobile window interface and the fixed window interface may be available for use by the general public if installed on public transportation or in public areas. In one embodiment, both the mobile window interface and the fixed window interface display information to the user and allows information to be entered by the user through the same display. In one embodiment, a user authentication mechanism such as a fingerprint recognition unit or other mechanism may be built directly into the card. In addition, the personal transaction device 170 may also contain wireless data communication, data storage and communication protocols for selectively communicating with outside devices such as a digital wallet described herein, point-of-sale terminal, or personal computer, and digital televisions.

In one embodiment, the personal transaction device 170 is configured to manage and control access to content and/or transactions received by individual accounts associated with the users of the personal transaction device. In one embodiment, the personal transaction 170 is configured to control the individual accounts by way of entering a unique biometric identifier associated with that particular account. Further, the user may select different information by entering unique biometric identifiers through the personal transaction device 170.

In an alternate embodiment, account management and control of access to content is achieved through the PTD 170. The PTD 170 may assign particular accounts with varying levels of content access and may place accounts into convenient groupings for account management.

In one embodiment, the personal transaction device 170 is configured to automatically handle contextual information and share this information with appropriate parties on behalf of the user.

In an alternate embodiment, the PTD 170 may be any suitable device that allows unrestricted access to TPCH 115. In one embodiment, the personal transaction device 170 may include a full screen that covers one side of the card. Alternately, in one embodiment in which the personal transaction device 170 is one embodiment of a privacy card, the privacy card may be coupled to device such as a digital wallet described herein, that provides a display. In one embodiment, the screen may be touch sensitive and be used for data input as well as output. In one embodiment, a user authentication mechanism such as a fingerprint recognition or other mechanism may be built directly into the card. Furthermore, the privacy card may have a wireless communication mechanism for input and output.

A variety of user interfaces may be used. In one embodiment, and input device may be incorporated on the transaction device. Alternately, a supplemental input device may be coupled to the transaction device. In one embodiment, an input device may be provided on a digital wallet coupled to a privacy card. User inputs may be provided on the point-of-sale terminals including a personal point-of-sale terminal.

The personal transaction device information is provided to the TPCH 115 that then indicates to the vendor 125 and the user 140 approval of the transaction to be performed. The transaction device utilizes an identification to maintain confidentiality of the user's identity by applying the transaction device identification and the identity of the entity performing the transaction. Thus, all transactions, from the vendor's perspective, are performed with the transaction device.

In order to maintain confidentiality of the identity of the user 140, the transaction device information does not provide user identification information. Thus, the vendor 125 or other entities do not have user information but rather transaction device information. The TPCH 115 maintains a secure database of transaction device information and user information. In one embodiment, the TPCH 115 interfaces to at least one financial processing system 120 to perform associated financial transactions, such as confirming sufficient funds at the vendor account 125 to perform the reverse payment transaction, and transfers to the user 140 the funds required to complete the transaction. In another embodiment, the TPCH 115 interfaces to at least one financial processing system 120 to perform associated financial transactions, such as confirming sufficient funds to perform the transaction, and transfers to the vendor 125 the fees required to complete the transaction. In addition, the TPCH 115 may also provide information through a distribution system 130 that, in one embodiment, can provide a returned product to the vendor 125 from the user 140, again without the vendor 125 knowing the identification of the user 140. In addition, the TPCH 115 may also provide information through a distribution system 130 that, in one embodiment, can provide a purchased product to the user 140, again without the vendor 125 knowing the identification of the user 140. In an alternate embodiment, the financial processing system 120 need not be a separate entity but may be incorporated with other functionality. For example, in one embodiment, the financial processing system 120 may be combined with the TPCH 115 functionality.

In one embodiment, the financial processing system (FP) 120 performs tasks of transferring funds between the user's account and the vendor's account for each transaction. In one embodiment, the presence of the TPCH 115 means that no details of the transactions, other than the amount of the transactions and other basic information, are known to the FP 120. The TPCH 115 issues transaction authorizations to the FP 120 function on an anonymous basis on behalf of the user over a highly secure channel. The FP 120 does not need to have many electronic channels receiving requests for fund transfer, as in a traditional financial processing system. In one embodiment, a highly secure channel is set up between the TPCH 115 and the FP 120; thus, the FP 120 is less vulnerable to spoofing.

In one embodiment, the TPCH 115 contacts the FP 120 and requests a generic financial approval of a particular account. Thus, the FP 120 receives a minimal amount of information. In one embodiment, the transaction information, including the identification of goods being purchased with the credit need not be passed to the FP 120. The TPCH 115 can request the credit using a dummy charge ID that can be listed in the monthly financial statement sent to the user, so that the user can reconcile his financial statement. Further, the personal transaction device 170 can include functionality to cause the financial statement to convert the dummy charge ID back to the transactional information so that the financial statement appears to be a conventional statement that lists the goods that were purchased and the associated amount charged.

A display input device 160 (shown in phantom) may be included to enable the user, or in some embodiments the vendor 125, to display status and provide input regarding the PTD 170 and the status of the transaction to be performed.

In yet another embodiment, an entry point 110 interfaces with the personal transaction device 170 and also communicates with the TPCH 115. The entry point 110 may be an existing (referred to herein as a legacy POS terminal) or a newly configured point of sale (POS) terminal located in a retail environment. The user 140 uses the PTD 170 to interface to the POS terminal in a manner similar to how credit cards and debit cards interface with POS terminals. The entry point 110 may also be a public kiosk, a personal computer, or the like.

In another embodiment, the PTD 170 interfaces through a variety of interfaces including wireless interfaces such as BlueTooth and infrared transmission; contactless transmission such as FeliCa and AmexBlue; and plug-in port transmission such as USB and RS-232C. A stand-in processor 155 (STIP) can interface with the PTD 170 in the event that the connection between the front end and the back end is disrupted for any reason. This way, the PTD 170 can gain authorization for a specified floor limit without necessarily receiving authorization from the back end. Further, this limits the amount of authorization thus minimizing fraud and insufficient funds.

The system described herein also provides a distribution functionality 130 whereby products purchased via the system are distributed. In one embodiment, the distribution function 130 is integrated with the TPCH 115 functionality. In an alternate embodiment, the distribution function 130 may be handled by a third party. Utilizing either approach, the system ensures user privacy and data security. The distribution function 130 interacts with the user through PTD 170 to ship the product to the appropriate location. A variety of distribution systems are contemplated, for example, electronic distribution through a POS terminal coupled to the network, electronic distribution direct to one or more privacy cards and/or digital wallets, or physical product distribution. In one embodiment for physical product distribution, an “anonymous drop-off point”, such as a convenience store or other ubiquitous location is used. In another embodiment, it involves the use of a “package distribution kiosk” that allows the user to retrieve the package from the kiosk in a secure fashion. However, in one embodiment, the user may use PTD 170 to change the shipping address of the product at any time during the distribution cycle.

A user connects to and performs transactions with a secure transaction system (such as shown in FIG. 1) through a personal transaction device (PTD) that has a unique identifier (ID). In one embodiment, a privacy card is used. In an alternate embodiment a digital wallet is used. In yet another alternate embodiment, a privacy card in conjunction with a digital wallet are used.

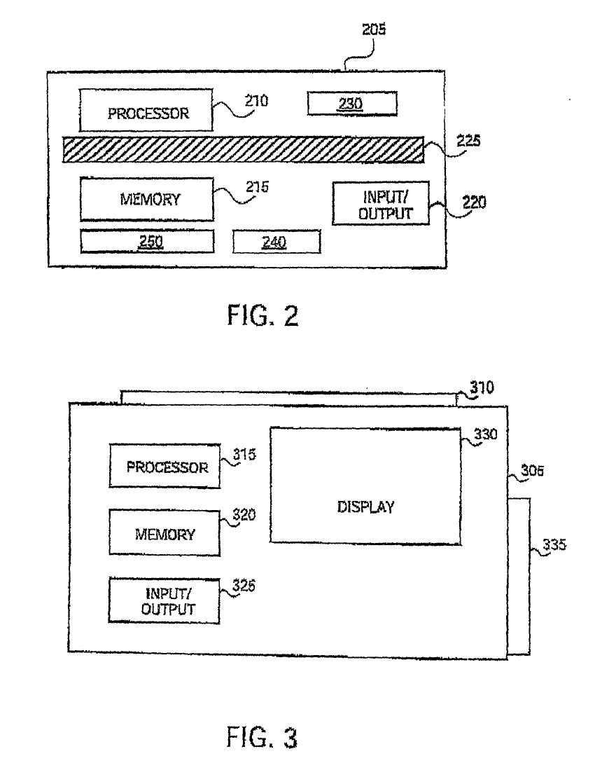

FIG. 2 is a simplified block diagram of one embodiment of a privacy card 205 for a personal transaction device. As illustrated in FIG. 2, in one embodiment, the card 205 is configured to be the size of a credit card. The privacy card includes a processor 210, memory 215 and input/output logic 220. The processor 210 is configured to execute instructions to perform the functionality herein. The instructions may be stored in the memory 215. The memory is also configured to store data, such as transaction data, user preferences, and the like. In one embodiment, the memory 215 stores the transaction ID used to perform transactions in accordance with the teachings of the present invention. Alternately, the processor may be replaced with specially configured logic to perform the functions described here.

The input/output logic 220 is configured to enable the privacy card 205 to send and receive information. In one embodiment, the input/output logic 220 is configured to communicate through a wired or contact connection. In another embodiment, the logic 220 is configured to communicate through a wireless or contactless connection. A variety of communication technologies may be used.

In one embodiment, a display 225 is used to generate bar codes scanable by coupled devices and used to perform processes as described herein. The privacy card 205 may also include a magnetic stripe generator 240 to simulate a magnetic stripe readable by devices such as legacy POS terminals.

In one embodiment, biometric information, such as fingerprint recognition, is used as a security mechanism that limits access to the card 205 to authorized users. A fingerprint touch pad and associated logic 230 is therefore included in one embodiment to perform these functions. Alternately, security may be achieved using a smart card chip interface 250, which uses known smart card technology to perform the function.

Memory 215 can have transaction history storage area. The transaction history storage area stores transaction records (electronic receipts) that are received from POS terminals. The ways for the data to be input to the card include wireless communications and the smart card chip interface which functions similar to existing smart card interfaces. Both of these approaches presume that the POS terminal is equipped with the corresponding interface and can therefore transmit the data to the card.

Memory 215 can also have user identity/account information block. The user identity/account information block stores data about the user and accounts that are accessed by the card. The type of data stored includes the meta account information used to identify the account to be used.

In another embodiment, the memory 215 also stores the embedded content received by the privacy card.

In another embodiment, the memory 215 also stores the account management information such as categories and the account access levels of content.

In another embodiment, the memory 215 also stores the contextual information gathered by the personal transaction device.

In yet another embodiment, the memory 215 also stores profile information that is initialized by the user and reflects the user's preferences for mid-stream payments to the merchant.

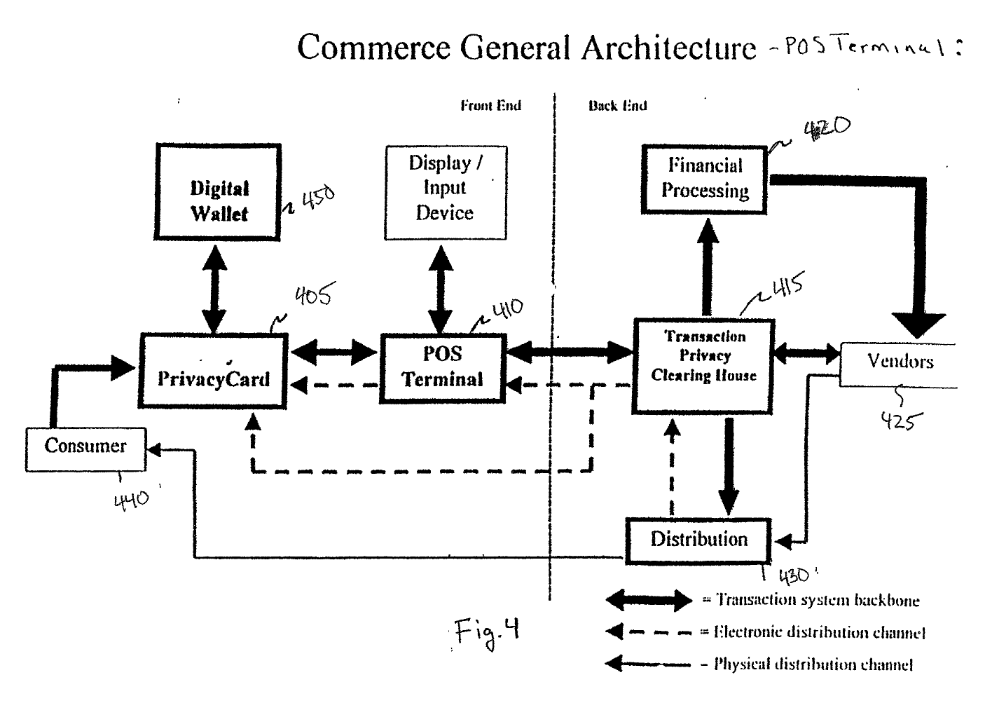

FIG. 3 is a simplified block diagram of one embodiment for a personal transaction device 305. As illustrated in FIG. 3, the PTD 305 includes a coupling input 310 for the privacy card 205, processor 315, memory 320, input/output logic 325, display 330, and peripheral port 335. The processor 315 is configured to execute instructions, such as those stored in memory 320, to perform the functionality described herein. Memory 320 may also store data including financial information, eCoupons, shopping lists, embedded content, and the like. The PTD 305 may be configured to have additional storage. In one embodiment, the additional storage is in a form of a card that couples to the device through peripheral port 310.

In one embodiment, the privacy card 205 couples to the PTD 305 through port 310; however, the privacy card 205 may also couple to the PTD 305 through another form of connection including a wireless connection.

Input/output logic 325 provides the mechanism for the PTD 305 to communicate information. In one embodiment, the input/output logic 325 provides data to a point-of-sale terminal or to the privacy card 205 in a pre-specified format. The data may be output through a wired or wireless connection.

The PTD 305 may also include a display 330 for display of status information to the user.

The transaction device enhances security by authenticating the user of the card prior to usage such that if that transaction device is useless in the hands of an unauthorized person. One means of authentication is some type of PIN code entry. Alternatively, authentication may be achieved by using more sophisticated technologies such as a biometric solution. This biometric solution can include fingerprint recognition, voice recognition, iris recognition, and the like. In addition, in one embodiment in which multiple transaction devices are used, it may be desirable to configure the first device to enable and program the second device in a secure manner. Thus, the means of communication between the first device in the second device may include mutual device verification such that an unauthorized first device may not be used to enable a particular second device that does not belong to the same or authorized user.

In one embodiment, the transaction device, point of sale terminals and/or TPCH may function to verify the authenticity of each other. For example the transaction device may be configured to verify the legitimacy of the point-of-sale terminal and/or TPCH. A variety of verification techniques may be used. For example, in one embodiment, the public key infrastructure may be used to verify the legitimacy of the user.

Communication protocols include those that allow the digital wallet to specify which of several possible data structures to use for a transaction and communication protocols that allow the digital wallet and other devices to securely share data with the transaction device. The transaction device may represent a single account such as a particular credit card, or it may represent multiple accounts such as a credit card, telephone card, and debit card.

In one embodiment, the transaction device is intended to be the means by which the user interfaces with the invention. In one embodiment, the transaction device stores e-commerce related data on behalf of the user including transaction histories, meta account information needed to carry out a transaction using the transaction privacy clearinghouse function of the system, and various content. In one embodiment, the meta account information may be an abstraction of the user's real identity as opposed to the actual user's name, address, etc. For example, the TPCH keeps records of the user's real bank account numbers, but assigned a different number for use by retailers and point-of-sale terminals. For example, and actual Bank Account No. may be 1234 0000 9876 1423 could be represented as 9999 9999 9999 9999. This number, in association with the transaction card's identification, could enable the TPCH to know that the bank account No. 1234 0000 9876 1423 was actually the account being used.

The purpose of this data is to abstract the user's identity while at the same time providing the necessary information for the transaction to be completed.

In one embodiment, the personalization process of the transaction device may be as described below. In this example, the transaction device is a digital wallet. The user turns on the transaction device. This can be accomplished by touching the finger print recognition pad or simply turning a switch. The transaction device performs at start a procedure, and recognizes that it has not yet been personalized. Thus, it first prompt the user to enter the secret pin code. If the pin code entry fails, the user is prompted again. Ideally the user is given a finite number of chances to enter the data. After the last failure, the device may permanently disable itself and thus becomes useless. It may also display a message requesting that the transaction device be returned to an authorized facility.

Assuming a successful pin code entry, the user may then be prompted to answer several of the security questions which were entered into the transaction device at processing center. Some of these questions might require data entry, and others might be constructed as simple multiple-choice, with both the correct as well as incorrect answers supplied. Assuming successful response to these questions, the user may then be prompted to enter secure personal identification information such as fingerprint data. In one embodiment, in which the fingerprint data is used, the user is prompted to enter fingerprint data by successively pressing one or more fingers against the recognition pad. The device prompt the user for each fingerprint that must be entered, for example, using a graphical image of a hand with the indicated finger.

The fingerprint data entry process may be performed at least twice to confirm that the user has entered the correct data. If confirmation succeeds, the device writes the fingerprint image data into their write once memory, or other memory that is protected from accidental modification. If confirmation fails, the user is prompted to start over with entry. Failure to reliably enter the fingerprint data after a finite number of tries will result in the device permanently disabling itself, and optionally providing an on-screen message to the user to go to secure processing facility such as a bank to complete the process. After successful personalization, the device is then ready to be used for the initial set of services that the user requested during the registration process. Once the device has been initialized for secure transactions, additional services could be downloaded to the device.

In one embodiment, the authentication of the identity of the user and selecting particular information by the user may be combined by the user providing a unique biometric input which corresponds to the particular selected information.

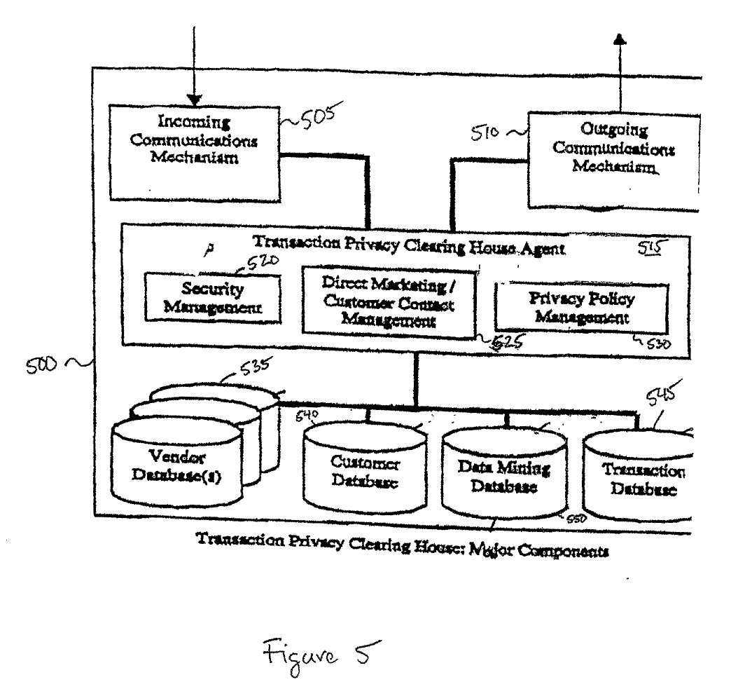

One embodiment of the system that utilizes a point-of-sale terminal is shown in FIG. 4. In this embodiment, the privacy card 405 interfaces with the point-of-sale terminal 410 and that point of sale terminal 410 communicates with that TPCH 415. That TPCH 415 interfaces with the financial processing system 420, the vendor 425 and the distribution system 430. The point-of-sale terminal may be an existing or newly configured point-of-sale terminal located in a retail environment. The user 440 uses the privacy card 405 to interface to the point-of-sale terminal a manner similar to how credit cards and debit cards interface with point-of-sale terminals. Alternately, a digital wallet 450 may be used by itself or with the privacy card 405 to interface to the point-of-sale terminal 410. Alternately, a memory device may be utilized solely as the interface with that point-of-sale terminal 410.

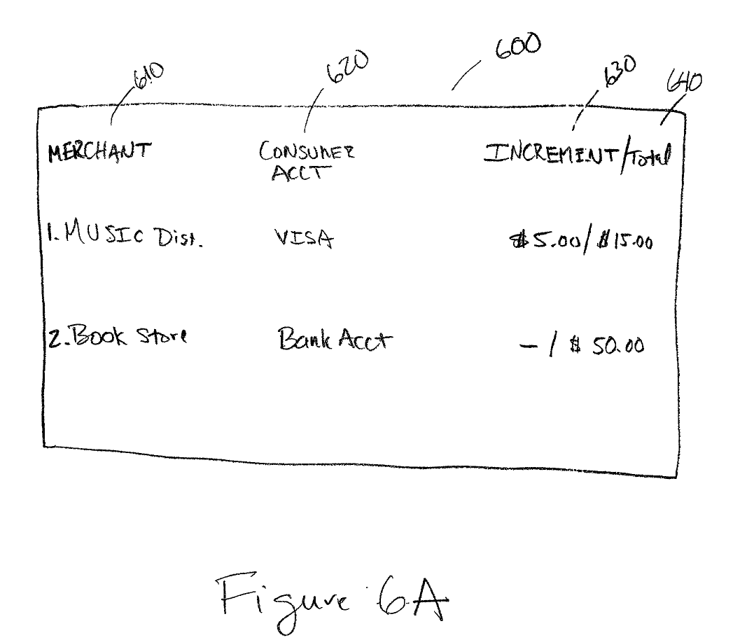

One embodiment of the TPCH is illustrated in FIG. 5. In one embodiment, the TPCH 500 is located at a secure location and is accessible to the transaction device. The TPCH 500 functions to provide the user with authorization to perform transactions without compromising the user's identity. The TPCH 500 may be embodied as a secure server connected to the transaction device in some form of direct connection or alternately a format in direct connection over the Internet or point-of-sale network.

Incoming communications mechanism 505 and outgoing communications mechanism 510 are the means of communicating with external retailers and vendors, as well as the transaction device such as the digital wallet. A variety of communication devices may be used, such as the Internet, direct dial-up modem connections, wireless, cellular signals, etc.

The TPCH agent 515 handles system management and policy control, informs their core functionality of the TPCH 500. In one embodiment, within the entire system, there is one clearinghouse agent, which resides permanently at the clearinghouse. Among the responsibilities handled by the agent include internal system management functions such as data mining, financial settlement and allocation of payments to internal and external accounts, embedded content management, and registration of new users joining the system.

The security management functions 520 ensure secure communications among the component internal to the TPCH 500 and the entities external to the TPCH 500. This function includes participating in secure communications protocols to open and maintain secure connections. This ensures that only authorized entities are allowed to access to data and that only authorized transaction devices can execute transactions against a user's account.

The TPCH agent 515 also provides a direct marketing and customer contact service 525, which in one embodiment is a data access control mechanism and maintain separate, secure access between various client and their databases. The data access control mechanism ensures that vendors have access only to the appropriate data in order to carry out the tasks of the system. One of the key features at the TPCH 500, the ability to carry out focused direct marketing while maintaining the privacy and identity protection of consumer, is handled by this mechanism.

The TPCH agent 515 can be configured to actively look for content on behalf of the user as well as filter out unwanted incoming information. In one embodiment, the data may be described by XML and the agent may operate via Java applets.

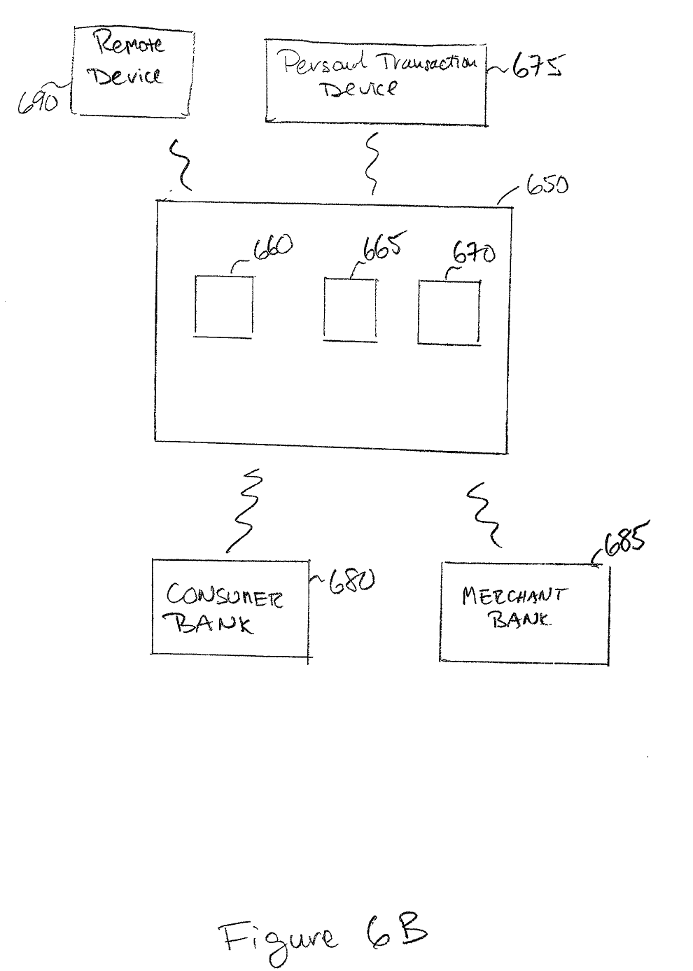

FIG. 6A illustrates one embodiment of a stored profile information 600. The stored profile information 600 may be locally stored within a personal transaction device or remotely stored at a secured location. The stored profile information 600 includes merchant list 610, consumer account list 620, increment of payment 630, and total transaction cost 640. In one embodiment, the merchant list 610 identifies a list of merchants that the consumer wishes to utilize for the method and system of mid-stream payment. The consumer account list 620 identifies a corresponding account associated with each merchant within the merchant list for payment to the associated merchant. The consumer account list 620 may include credit cards, checking accounts, savings accounts, brokerage accounts, monthly services, and the like.

The increment of payment 630 is associated with each merchant and allows for a predetermined amount of money to be transferred to the merchant for each discrete payment using the method and system of mid-stream payment. The total transaction cost 640 is associated with each merchant and allows for a predetermined maximum amount of money to be transferred to the merchant for the entire transaction using the method and system of mid-stream payment.

For example, under the merchant list 610, the music distribution company corresponds to the Visa account information under the consumer account 620. Similarly, the book store company under the merchant list 610 corresponds with the bank account under the consumer account 620. The $5.00 increment of payment 630 associated with the music distribution company under the merchant list 610 sets $5.00 as the amount to be transferred to the music distribution company. Additionally, the $15.00 limit under the total transaction cost 640 associated with the music distribution company under the merchant list 610 limits the total amount to be transferred from the consumer to the music distribution company. Similarly, the $50.00 limit under the total transaction cost 640 associated with the book store company limits the amount to be transferred from the consumer to the book store company. In one embodiment, the total transaction cost 640 may be set aside with authorization from the consumer.

FIG. 6B illustrates a simplified block diagram of a payment system 650. In one embodiment, the payment system 650 operates within a secure transaction system outlined in FIG. 1. The payment system 650 may be included in the front end or back end of the secure transaction system. The payment system 650 may communicate with a remote device 690, a personal transaction device 675, a consumer bank 680, and/or merchant bank 685.

The payment system 650 includes a matching module 660, a connection module 665, and a transfer module 670. The matching module 660 performs matching functions between a merchant and a merchant list contained within the profile information. In one embodiment, the merchant may be communicated to the payment system through the personal transaction device 675. In one embodiment, the merchant list may be accessed from the profile information stored on the personal transaction device 675. In another embodiment, the merchant list may be accessed from the profile information stored on the remote device 690.

In one embodiment, the connection module 665 is configured to automatically connect the merchant bank 685 with the consumer bank 680. In another embodiment, the connection module 665 is configured to connect the merchant bank 685 with the consumer bank 680 after confirmation from the consumer and/or the merchant.

In one embodiment, the transfer module 670 securely transfers funds from the consumer bank 680 to the merchant bank 685.

In one embodiment, the method and system of mid-stream payment allows for payment to a merchant from a consumer in real-time based on a pay per minute scheme, pay per byte scheme, pay per subscription rate scheme, and pay per limited use scheme. The pay per minute scheme is analogous to a phone card system. The pay per byte scheme is analogous to a paying a fee based on the amount of content consumed by the consumer. The pay per limited use scheme is analogous to a single use model where the consumer connects once to play an unlimited number of games. The pay per subscription rate scheme is analogous to a flat rate buffet type of use where the consumer is able to use in an unlimited fashion.

In one embodiment, the method and system of mid-stream payment includes the ability to automatically transfer funds from the consumer to the merchant during the purchase of goods or services. Further, the method and system of mid-stream payment can be configured to not need intervention from the consumer and can avoid interruption of the delivery of goods or services to the consumer. In some cases, additional confirmation by the consumer may be needed to protect the consumer from an unauthorized transfer of funds. This confirmation may include verifying the authenticity of the consumer's identity. Further, the method and system of mid-stream payment may compensate the merchant while keeping the consumer's identity anonymous.

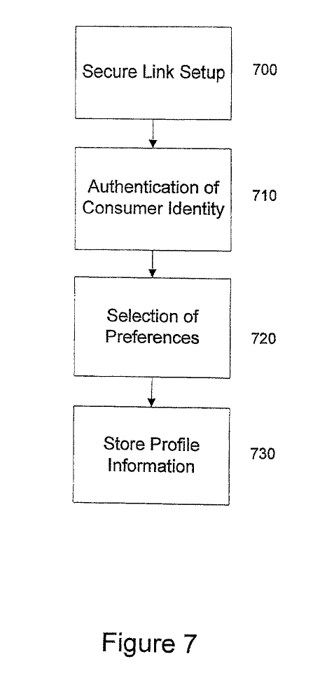

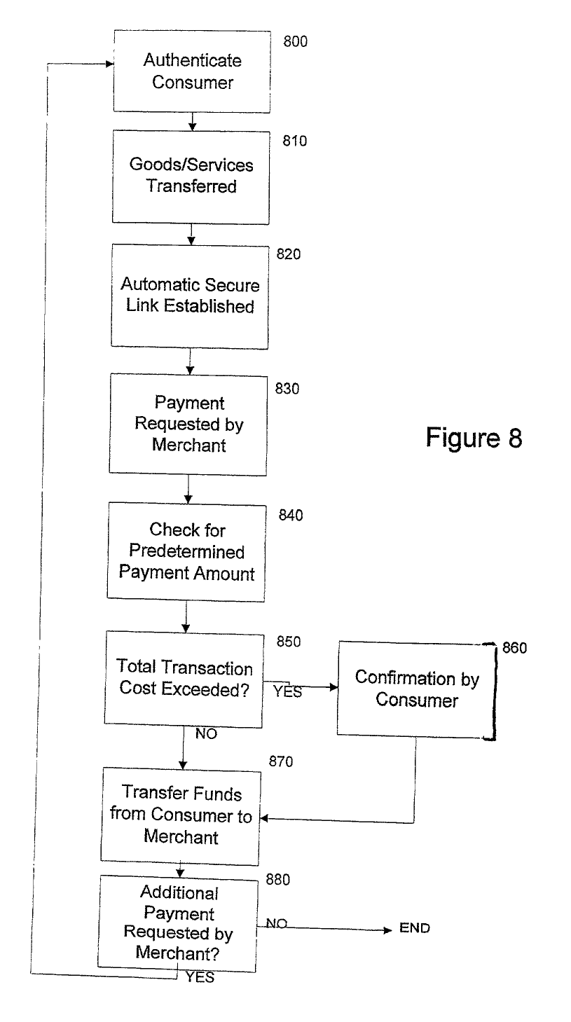

The flow diagram as depicted in FIGS. 7 and 8 are merely one embodiment of the invention. The blocks may be performed in a different sequence without departing from the spirit of the invention. Further, blocks may be deleted, added or combined without departing from the spirit of the invention.

FIG. 7 illustrates one embodiment of a user initialization of the reverse payment model. In Block 700, a link is established between the user and the method and system of mid-stream payment. In Block 710, authentication of the identity of the consumer is confirmed by either receiving a token, receiving a PIN, receiving a biometric parameter, or the like. In Block 720, profile information is entered and/or edited. An exemplary form of profile information is described and shown in FIG. 6. In Block 730, the profile information is stored either locally within the device or remotely.

FIG. 8 illustrates one embodiment of the method and system of midstream payment. In Block 800, authentication of the identity of the consumer is confirmed by either receiving a token, receiving a PIN, receiving a biometric parameter, or the like. In Block 810, goods and/or services are transferred from the merchant to the consumer. In Block 820, a secure link is automatically established between the merchant bank and the selected consumer account designated by the consumer through the profile information without additional interaction by the consumer or the merchant. The merchant is matched with a merchant on the merchant list 610 (FIG. 6) within the profile information. In one embodiment, this link is established during the transfer of the goods and/or services from the merchant to the consumer. In Block 830, a payment request is automatically sent from the merchant to the consumer. In Block 840, an increment of payment is searched within the profile information for this particular merchant. The increment of payment is the payment amount. If the increment of payment is not available for this particular merchant, then the payment request contains a payment amount.

In Block 850, a check is performed to determine if the summation of payment amounts for this entire transaction exceeds the total transaction cost which is preselected by the consumer in the profile information. If the summation of these payment amounts exceeds the total transaction cost, the consumer is asked to provide confirmation in Block 860. After this confirmation or if the summation of these payment amounts do not exceed the total transaction cost, then funds for the payment amount are transferred from the consumer account to the merchant in Block 870. In Block 880, if there are additional payments requested by the merchant, the process loops back to the Block 830.

In one embodiment, the transfer of the goods and/or services from the merchant to the consumer as described in the Block 810 may occur during events described in the Blocks 800, 820, 830, 840, 850, 860, 870, and/or 880. In one embodiment, the consumer's true identity may remain anonymous to the merchant by utilizing secure transaction processes as described in FIGS. 1 and 5. In one embodiment, the transactional processing of transferring funds is accomplished through secure backoffice activities and applications as described in FIGS. 1 and 5.

The foregoing descriptions of specific embodiments of the invention have been presented for purposes of illustration and description.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A payment system comprising:
a. a matching module for matching a merchant to a plurality of listed merchants from a merchant list and identifying a selected consumer account based on the merchant;
b. a connection module coupled to the matching module for automatically connecting the merchant with the selected consumer account; and
c. a transfer module coupled the connection module for transferring funds from the selected consumer account to the merchant in response to a confirmation.

2. The system according to claim 1 wherein the confirmation is based on an amount of the funds not exceeding a predetermined amount.

3. The system according to claim 1 wherein the confirmation is based on receiving an authentication of an identity of the consumer.

4. The system according to claim 1 further comprising an input module for receiving the confirmation from the consumer.

5. The system according to claim 4 wherein the funds are one of traditional currency, electronic currency, store credit, and loyalty credit.

6. A method comprising:
a. receiving a request for a payment amount from a merchant;
b. matching the merchant with a selected consumer account from profile information; and
c. transferring the payment amount from the consumer account to the merchant.

7. The method according to claim 6 further comprising checking the payment amount relative to a limit amount.

8. The method according to claim 7 further comprising authorizing the payment amount when the payment amount exceeds the limit amount.

9. The method according to claim 7 wherein the limit amount is established by a total transaction cost.

10. The method according to claim 7 wherein the limit amount is established by an increment payment.

11. The method according to claim 6 further comprising authenticating an identity of a consumer associated with the consumer account.

12. The method according to claim 6 further comprising establishing a link between the merchant and the selected consumer account.

13. The method according to claim 6 further comprising confirming wherein the funds comprise one of traditional currency, electronic currency, store credit, and loyalty credit.

14. A method of initializing comprising:
a. authenticating an identity of a consumer;
b. receiving a consumer account from the consumer for use with a merchant; and
c. associating the consumer account with the merchant.

15. The method according to claim 11 wherein authenticating the identity is accomplished by receiving a biometric parameter from the consumer.

16. The method according to claim 11 further comprising storing the merchant and the consumer account.

17. The method according to claim 11 further comprising receiving a total transaction cost associated with the merchant.

18. The method according to claim 11 further comprising receiving an increment payment associated with the merchant.

19. The method according to claim 11 wherein authenticating the identity is accomplished by receiving a PIN from the consumer.

20. A computer-readable medium having computer executable instructions for performing a method comprising:
a. receiving a request for a payment amount from a merchant;
b. matching the merchant with a selected consumer account from profile information; and
c. transferring the payment amount from the consumer account to the merchant.
